(19) United States
(12) Patent Application Publication
(10) Pub. No.: US 2008/0094185 A1
(43) Pub. Date: Apr. 24, 2008

(54) PATRON COMMUNICATION SYSTEM

(76) Inventor: Laura Kreiss, Rancho Santa Fe, CA (US)

Correspondence Address: KLEINBERG & LERNER, LLP, 2049 CENTURY PARK EAST, SUITE 1080, LOS ANGELES, CA, 90067, US

(21) Appl. No.: 11/550,556

(22) Filed: Oct. 18, 2006

(51) Int. Cl. G08B 5/36

(52) U.S. Cl. 340/286.09

(57) ABSTRACT

A patron communication system facilitates communication between patrons and the service staff assigned to them by means of transmitter element programmed to transmit at least two different wireless signals, corresponding, respectively, to different patron requests. A central receiver element receives and identifies the transmitted signals. At least one remote receiver element receives signals identifying a transmitter element and the nature of the transmitted signal. A data processor connected to the central receiver element, generates signals at said receiver elements, including information as to the identity of the transmitter and the nature of the purpose of the transmitted signal.

### CROSS REFERENCE TO RELATED APPLICATIONS

N/A

### STATEMENT REGARDING FEDERALLY SPONSORED RE SEARCH/DEVELOPMENT

N/A

### REFERENCE TO MICROFICHE APPENDIX

N/A

### BACKGROUND OF THE INVENTION

1. Field of the Invention

The present invention relates to service establishments and, more particularly, establishment wherein patrons wish to communicate with service staff.

2. Description of the Related Art

In the typical restaurant, a seated patron frequently wishes to communicate with the staff person who has been assigned to provide service. It is often difficult to attract the attention of a busy waiter in crowded and possibly noisy environments. Usually hand gestures are insufficient to attract the attention of the staff person assigned to the table.

In the past, call buttons that provide a signal on an annunciator board, have been employed, but these required that each staff person frequently check the board to see if their table wishes services. Others have utilized table ornaments that illuminate as a signal to the support staff. Yet other approaches have utilized a pushbutton or light switch that illuminated a call lamp near the table.

None of the prior art approaches have achieved universal acceptance and therefore the need for a communication system and server still exists. Furthermore, none of the prior art provides all of the benefits of the present invention.

### SUMMARY OF THE INVENTION

According to the present invention, a modified paging system is provided which utilizes a base station in wireless communication with a plurality of transmitting devices, each placed at a separate, identifiable location, which, in the preferred embodiment, is a patron's table in a restaurant. A central computer receives the transmissions, retains the information and sends appropriate signals to various service providers within the establishment. These signals may be in numerous forms, visible indicators on a computer screen, audible indicators sent through a headset or printed form of indication.

In a restaurant setting, the central computer would communicate with the bar, the cashier, the kitchen and the individual members of the support staff. Each member of the support staff with patron responsibilities is provided with a receiver (or computer that can identify which of the assigned tables is seeking attention). Similarly, the cashier can be alerted to prepare a check for a patron who has signaled to the central computer requesting the check. A signal to the bar could result in a cocktail server being dispatched to the table requesting bar service.

In alternative embodiments, the system, with modification, could be adapted for use with bars, nightclubs, hotels and especially hospitals and nursing homes where a record could be maintained of requests for service and the response and response time to such requests by the staff, with notes of the time of the request and the time of the response. If the call for service can be differentiated into different kinds or types of service, the patron's signaling unit would have different call buttons, each for the different service request. Alternatively, a switch could select the desired service and a call button would send the appropriate signal.

In the restaurant setting, a patron's call device could request the waiter, bar service, or a check, each with a selected illumination at the transmitter or the table. When the desired service is provided, the illuminated signal could be extinguished. For management purposes, the computer can maintain a log noting, for each table and for each employee, the time that a request was made and the time that a response was made. This log could then be reviewed to determine which shifts, servers or time frames are challenging. Potentially, it could be used to increase response times and efficiency.

Accordingly, it is an object of the invention to provide a communication system that enables the provision of better service to a patron. It is a further object of the invention to provide a central communication station which can receive communicated requests and which can signal to appropriate staff members who can respond to such requests.

It is a further object of the invention to improve the efficiency of the operation and to shorten the waiting between the time that a patron has a service request and the time that the establishment fulfills that request. It is also an object of the invention to allow management to maintain a record of staff performance. It is a further object to automatically create this record of staff performance.

The novel features which are characteristic of the invention, both as to structure and method of the operation thereof, together with further objects and advantages thereof, will be understood from the following description, considered in connection with the accompanying drawings, in which the preferred embodiment of the invention is illustrated by way of example. It is to be expressly understood, however, that the drawings are for the purpose of illustration and description only, and they are not intended as a definition of the limits of the invention.

### BRIEF DESCRIPTION OF THE DRAWINGS

FIG. 1 is a plan view of a display at a central receiver according to a preferred embodiment of the present invention;

FIG. 2, including FIGS. 2A and 2B, are plan views of a patron's communication device;

FIG. 3, including FIGS. 3A and 3B, are a side and top view, respectively, of a support staff paging device showing a typical message;

FIG. 4 is a system block diagram of a preferred embodiment of the present invention in a food service environment; and

FIG. 5 is a system block diagram of an alternative embodiment of the present invention adapted for use in a personal care facility.

### DETAILED DESCRIPTION OF THE INVENTION

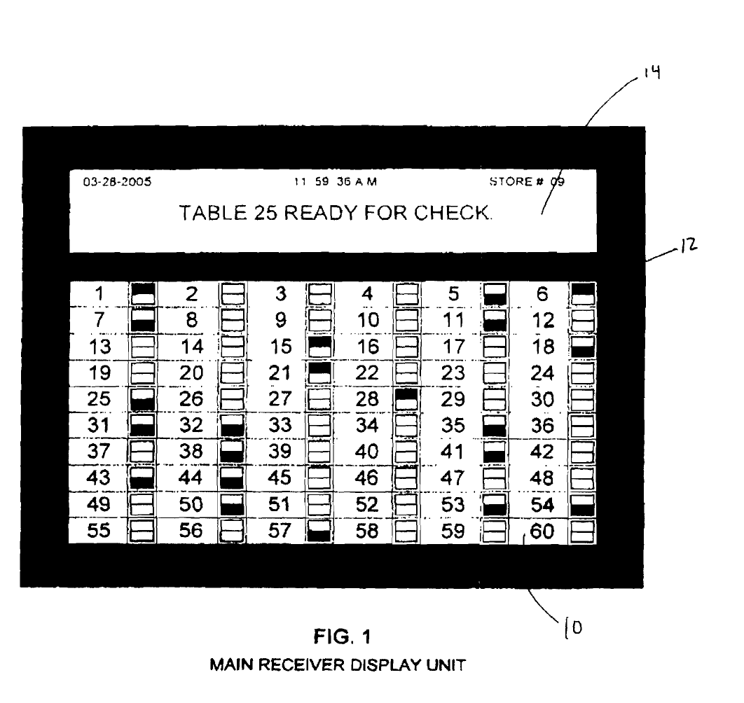

Turning to FIG. 1, there is shown a typical display board 10 for a restaurant having, in this example, 60 tables. A pair of signal displays 12 is allocated to each. One of the signal displays 12 can represent a call for a waiter while a second can represent a call for beverage service. A separate display area 14 can provide a message if a particular table wishes the check to be prepared and an appropriate text message identifying the table is displayed in a separate area. It is to be understood that the display of FIG. 1 is merely an example of the preferred embodiment. Numerous other embodiments of a display means or other method by which individuals, such as waiters, cashiers, food preparers, nurses and other service people may be made aware of clientele needs.

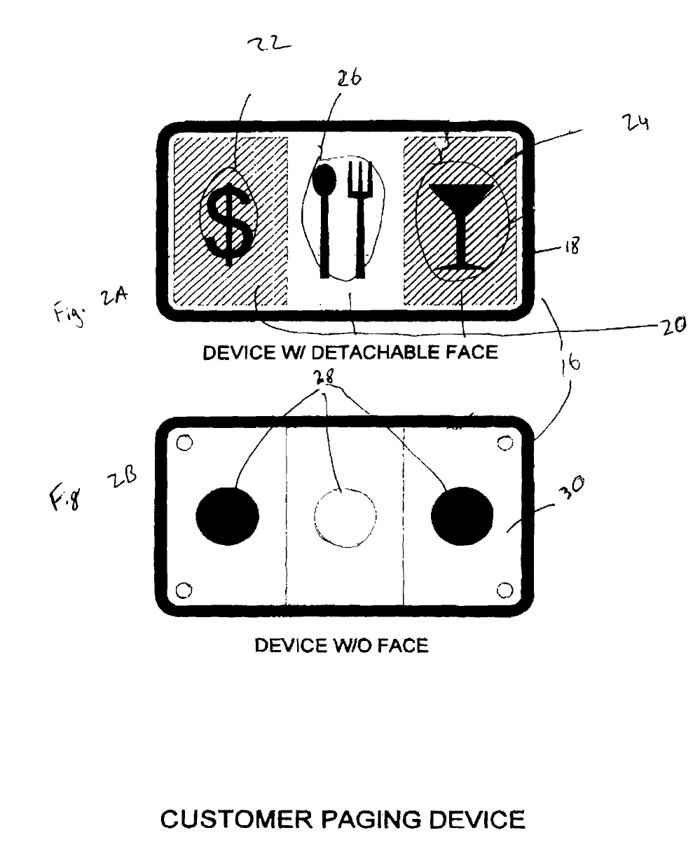

FIG. 2, which includes FIG. 2A and FIG. 2B, shows a patron communication device 16. In the present example, FIG. 2A shows the device with a faceplate 18 that can ascribe functions to available push buttons or keys 20. In the this example embodiment, each device can send up to three distinctive signals which, in FIG. 2A are identified as a call for a check 22, a call for beverage 24 or a call for the waiter 26, respectively indicated by a dollar sign, a cocktail glass and a fork and spoon image. It is to be understood that in alternative embodiments, any number of buttons may be used for any number of different meanings. The three used in this example embodiment may be supplemented or altered depending upon the use to be made of the system of this invention.

In alternative embodiments, a light source 28 (seen in FIG. 2B), such as an LED could remain on after the signal has been sent and would remain on until the desired service has been provided. To accommodate the illumination feature, the cover 30 of the device 16 shown in FIG. 2B can be translucent so that the desired service symbol remains illuminated. The device 16 may be provided with a light cancel feature, engaged either by actuating the signal again or through the use of an “off” switch. In response to the subsequent actuation, the central computer can send a signal to extinguish the light source 28 which the “off” switch can accomplish locally while, at the same time, signaling the central computer that the requested service has been delivered for purposes of creating and maintaining a record of the request and response.

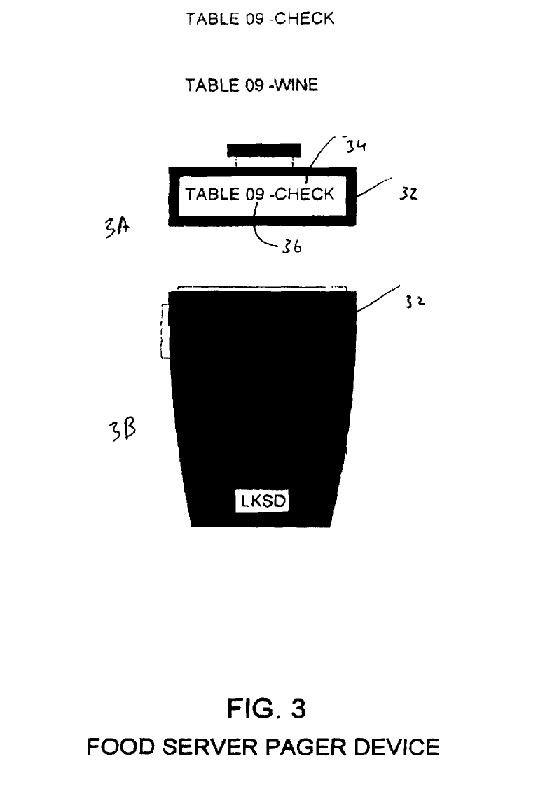

FIG. 3, including FIG. 3A and FIG. 3B, shows a pager-receiver 32 that is carried by the service staff. FIG. 3A shows the display face 34 in which text messages will appear. As with conventional pagers, the device can provide either a sound or vibration to alert the wearer that a message has been received. As shown in FIG. 3A, the message “TABLE 09-CHECK” 36 advises a waiter that he should proceed to the cashier and retrieve the check that he can then bring to table 09. Numerous other types of messages may be displayed based upon the type of scenario in which the system of this invention is deployed. For example, in a hospital or nursing home deployment, the message may be “ROOM 204—NURSE NEEDED” or some similar message.

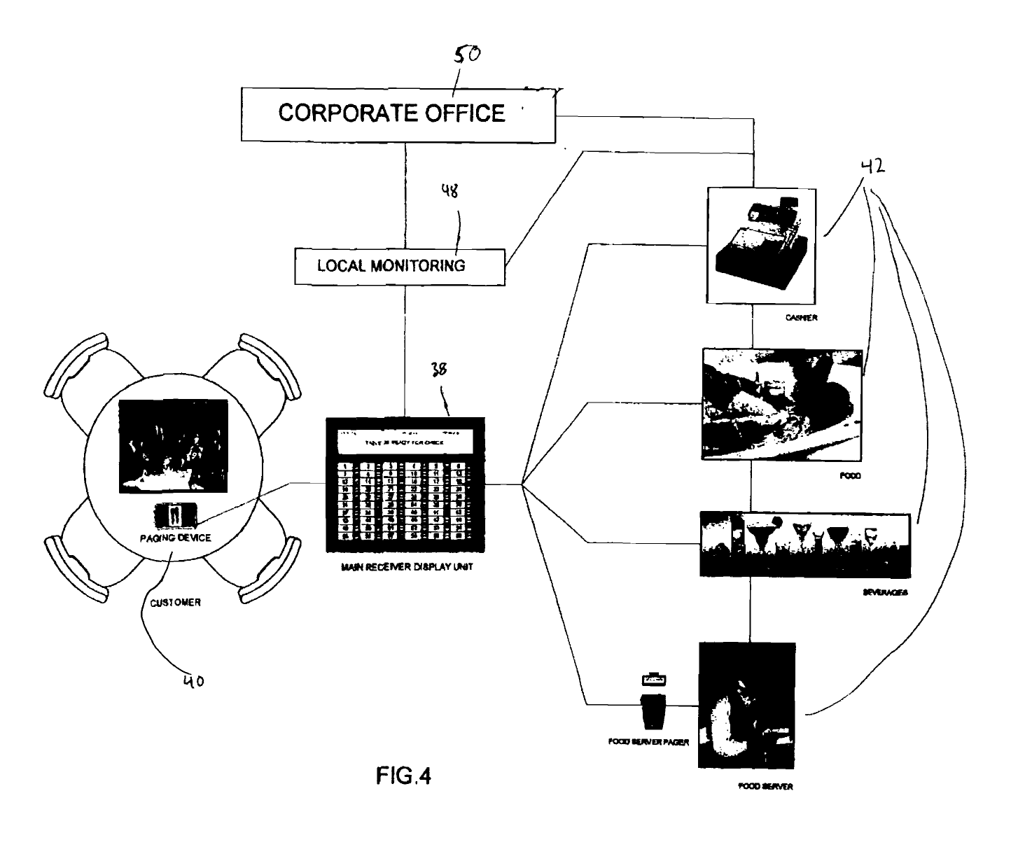

Turning next to FIG. 4, there is shown the system of the present invention in a restaurant embodiment. A central data processor 38 includes receiving and transmitting functions. The processor 38 can identify which of the several patrons 40 is transmitting a signal and for which available service. A signal is then sent to the appropriate service provider 42, which, in the illustrated system, could be the cashier, the kitchen, the bar or a server of food or beverages. For monitoring purposes, signals are also transmitted to a local monitoring station 48 and corporate offices 50.

In the preferred embodiment of the system, once the signal is sent to the appropriate service provider 42, then the service provider would respond with the desired service. Then, the signal's response time would be noted and would be sent to local monitoring station 48 and corporate offices 50. Logs could be maintained and updated at regular intervals concerning the on-going response times and request frequency of the individuals or groups being served.

The foregoing may be more easily understood through the use of an example. For purposes of this example, a patron at table 09 in a restaurant using the system of this invention desires another drink. The patron then looks to the customer paging device 16 on the table or otherwise available to him. He may then select the button 24 associated with “drink service” as provided on the customer paging device 16. The customer paging device 16 then makes contact, wirelessly, in the preferred embodiment, with the central data processor 38. The central data processor 38 contains programming sufficient to recognize the different types of requests being issued by customers. In the preferred embodiment, a method is provided whereby the central data processor 38 may be user-programmed for use in various different situations.

The central data processor 38 then provides a signal to the beverage preparer and the food server pager (as seen in FIG. 3 and FIG. 4, element 42) letting them both know that the patron at table 09 would like another drink. The food server then goes to table 09, takes a drink order and extinguishes the drink service light that remains on until the food server has completed the response. In the preferred embodiment, the request will be extinguished by the food server at the location by pressing an “off” button or simply repressing the service request button 24 again. In alternative embodiments, the food server may return to the kitchen or other suitable response input station, in the example, to input the drink order. At this point, the request would be automatically be reset as having had a response once the order is entered. The bartender would then receive the order and it would be delivered to the patron. A record of the request, including a time stamp and its general nature (drink request), would be saved and written to a log file for local monitoring 48 and at the corporate office 50.

As may also be understood from the foregoing, the system of this invention may be integrated into an existing order system. In modern restaurants, the orders are input into waiter stations typically via touch screens by the waiters and waitresses. These systems provide opportunity for the server to be available to the patrons more of the time with fewer trips back to the kitchen. As described above, in the drink request example, the system of this invention may be integrated in such a way as to provide that the same system that accepts orders provides feedback to servers, the kitchen and the like regarding patron requests. In one alternative, the service request may come to the waiter through the order system screen. Alternatively, as described above, the request may be cancelled once the waiter inputs and order for a patron into the system.

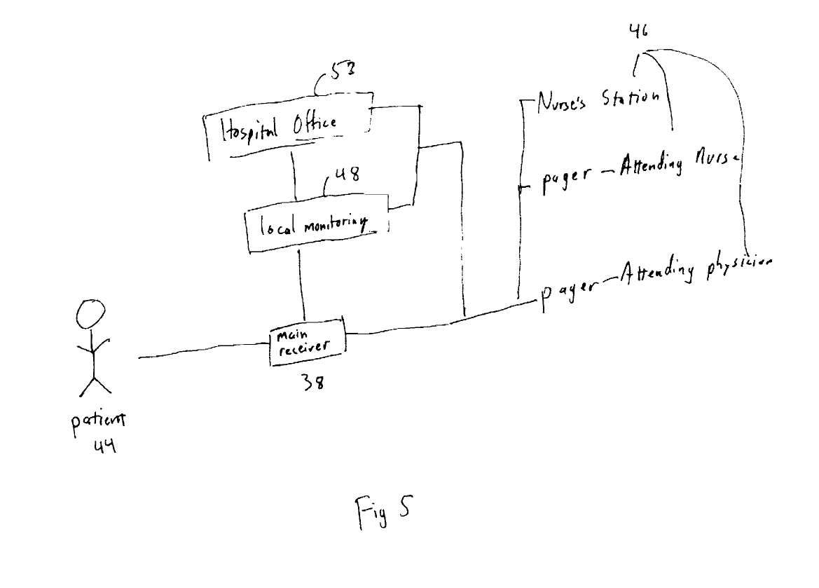

Turning to FIG. 5, there is shown a comparable system in a personal care facility, such as a nursing home or hospital. Again, a central data processor 38 includes receiving and transmitting functions. The processor 38 can identify which of the several patients 44 is transmitting a signal and for which available service. A signal is then sent to the appropriate service provider 46, which, in this illustrated system, could be the nurse's station, a pager carried by the attending nurse, a pager carried by the attending physician or any other service provider assigned to this particular patient. As the signal is sent it is, as above, simultaneously sent to the local monitoring station 48 and to the Hospital Office 52.

In some facilities, it may be appropriate for the patient to call for medication or food in which case a signal could be sent to the pharmacy, or for food or beverage, in which case a signal would be sent to the kitchen. One of the signals could represent a need for medial assistance or simply a need for attention to remedy a less-pressing need. Further, any patient monitoring system could be equipped to also send a signal for immediate, emergency assistance. In these situations, an auditory alarm may also be employed instead of or in addition to other signals to alert the appropriate staff members.

In both FIGS. 4 and 5, the central processor 38 also maintains records of when a request was sent and the time that an appropriate response was made to the request. This information can be useful either to a local monitor 48 of the operation or to a remote main office 50 or hospital office 52 where records will be kept. Problems in service can be identified and remedied. For example, if service by a particular nurse or to a particular patient is lacking over the course of a short period of time, then that nurse may be replaced or may be instructed to be more attentive to a particular individual. Alternatively, if a waiter is incapable of handling all of the assigned tables or if a whole series of waiters are incapable, then the group of tables may be lessened in number or the hostess may be alerted to spread the seating around among the servers more evenly. Further, employee performance can be monitored so that exemplary employees can be rewarded for their efforts.

As may be seen from the described embodiments, the present invention may be used in numerous scenarios not listed herein. For example, the system of this invention may be used on airliners in order to encourage more prompt service. Alternatively, the system of this invention may be used anywhere that patrons are being served at a location by a dedicated staff of servers of virtually any type. The system is easily adaptable to numerous scenarios.

The equipment to implement the present invention is currently available from existing, off-the-shelf components. Accordingly, the scope of the invention should not be limited to the illustrated application but can be extended to other environments with appropriate modifications of the equipment.

What is claimed is:

1. A patron communication system comprising:
(a) at least one transmitter element programmed to transmit at least two different wireless signals, corresponding, respectively, to different patron requests;
(b) a central receiver element for receiving and identifying signals from transmitter elements;
(c) a data processor connected to said central receiver element, operable in response to signals received from transmitter elements to generate signals including information as to the identity of the transmitter and the nature and purpose of the transmitted signal; and
(d) at least one remote receiver element for receiving data processor signals identifying a transmitter element and the nature of a signal transmitted therefrom.

2. The patron communication system as in claim 1 further comprising at least one lighting device coupled to said transmitter element operable to provide a visible signal in conjunction with transmission of said wireless signal.

3. The patron communication system as in claim 1, wherein said central receiver and data processor maintains a log of received transmitter element wireless signals and wireless signals generated and transmitted to said receiver elements.

4. The patron communication system as in claim 1 wherein said transmitter element further includes a removable translucent faceplate configured for the display of visible messages.

5. The patron communication system as in claim 1 wherein one of said wireless signals is a signal requesting medical attention.

6. The patron communication system as in claim 1 wherein one of said wireless signals is a signal requesting server assistance

7. The patron communication system as in claim 1 wherein said remote receiver element is a pager.

8. The patron communication system as in claim 1 wherein said remote receiver element includes a computer display.
